(19) United States
(12) Patent Application Publication
(10) Pub. No.: US 2009/0043706 A1
(43) Pub. Date: Feb. 12, 2009

(54) Money wiring address billing worldwide shipper online fraud detection system

(76) Inventor: Keith Anthony Washington, Oakland, CA (US)

Correspondence Address: Keith Anthony Washington, 2101 10th Ave, Oakland, CA, 94606, US

(21) Appl. No.: 11/891,095

(22) Filed: Aug. 9, 2007

(51) Int. Cl. G06Q 40/00

(52) U.S. Cl. 705/44

(57) ABSTRACT

A money wiring, address billing, online fraud detection system. A billing system that is of the utmost simplicity, ease of use. A billing system which bills and wires money with the actual numbers of a consumer's shipping address, and bills and wires money with the actual numbers of a consumer's telephone number. A system which wires money with a valued customer date and account expiration date. A billing system which uses all of these unique numbers to wire a consumer money, to prevent misuse of the billing systems numbers.

### BACKGROUND OF THE INVENTION

This invention relates to wiring money online.

### BACKGROUND—DESCRIPTION OF PRIOR ART

Banks and credit card issuers commonly supply consumers with credit cards. Cards to used at home, on the phone or online and in the mail. As more people use their cards more and more credit card numbers are being stolen. Thereafter, inventors have tried to create fraud proof credit cards. U.S. Pat. No. 5,259,649 to Shomron (1993) discloses a complex looking credit card, which can prevent fraud in some situations, but this card is not fraud proof.

In late 1998 Over forty million dollars, and around 900,000 victims across 22 countries have been victim to the biggest credit card fraud ever. Fraudulent credit card transaction generated using adult web site merchant accounts. A fascinating story this type of fraud has been going on for years. Criminal merchant account holders in collaboration with shady banks and transaction processors. It's an old story that predates the Internet.

What's new is the ability to run this scam across the entire world, and attack hundreds of thousands of victims in a very short period of time. The Internet has given old scams new legs. It has exposed the smoldering weaknesses in our credit card processing system. JK Publication ran a sizeable fraud, somewhere in the range of $40-50 million dollars, distributed across 900,000 credit cards, their merchant accounts had a chargeback rate 100 times the national average; each time a merchant account was closed by the credit card companies, they opened a new one.

According to L.A. Times story reporting on FTC investigations, CP bank sold Ken Tares about 900,000 credit card numbers that he allegedly used to run up $45.7 million in mostly bogus charges against consumers worldwide. Apparently the bank made millions processing credit card transactions for adult industries. There are some pretty crooked banks out there. Prosecution for this type of fraud is rare. Visa/Mastercard, who have the ultimate authority are not coordinating anti-fraud activities and are not providing the technology for a better transaction system. The thieves are guilty, but they're playing on a weak system. According to Visa & MasterCard, 22 million fraudulent credit card transaction occurred either online or off line of an estimated total of 25 billion transactions combined.

In late 2004 Holders of more than 40 million credit cards are vulnerable to financial fraud because their credit card information was stolen from an Arizona Company that processes transaction for Visa, Mastercard, American Express and Discover.

A computer hacker infiltrated the network of Cardsystems Solutions Inc. The theft is by far the biggest in a recent stream of security breaches and mishaps that have raised questions about whether the financial and personal data of cardholders and bank account holders is safe with the corporations and government entities that store it in databases.

Avivah Litan an analyst for Gartner Research who advises merchants and banks on Internet security and fraud. Mr. Litan said the thieves can sell the card numbers for $200 million to $350 million. 13 million Mastercard accounts compromised, 22 million Visa accounts compromised, one billion estimated cost of replacing 40 million credit cards.

The use of credit cards originated in the United States during the 1920s, when individual firms, such as oil companies and hotel chains, began issuing them to customers. However, references to credit cards have been made as far back as 1890 in Europe.

Today it is easy to commit fraud against credit cards, because one key factor has not changed in over one hundred years, and it is the root of the problem. Today if a person goes to a financial institution and completes a credit card application the institution will enter the person's information into a first computer database, which is connected to another database that will issue a random set of approved credit card numbers. The person's name is manually typed into this database.

This procedure is the reason credit card fraud exists today, and the banks and credit card companies do not know how to solve the problem. In 2005, credit card fraud cost the U.S. 60 billion in loses. If the U.S. continues to issue credit cards that have numbers that are meaningless, and selected at random, the country could suffer over a trillion dollars in loses, over a 20 year period. The Visa MasterCard transaction system was designed for traditional transactions of physical goods with a physical vendor and a physical card. Mail order stretched that system, but e-commerce blows it wide open.

It is a big misconception for the credit card companies that think the solution to this problem lies with spending billions of dollars developing some form of major technology or hardware. Hardware to solve the problems, change the card numbers, and the way the card numbers are issued, and the problems are solved.

### BRIEF SUMMARY OF THE INVENTION

An online money wiring billing system, that is of the utmost simplicity, ease of use. While at the same time, being highly effective in preventing misuse of the billing systems numbers. The numbers from the system are a built-in security feature. When this billing system is used online or on the telephone, and in the mail, the merchant will know right away if someone is trying to commit fraud. This system uses a consumer's address and telephone number as a money wiring fraud detection system.

### DETAILED DESCRIPTION OF THE INVENTION

The present invention presents a process that is identical to today's procedures, with one key difference, selective credit card numbers. The use of particular numbers, and the common procedure of entering numbers into a computer database, is what makes this money wiring system 100% fraud proof.

A person will go to an institution and complete a credit card application to receive a credit card. The institution will employ the actual numbers of the applicant's shipping address, and telephone number; as a money wiring, address billing, worldwide shipper, online fraud detection system.

The institution will be able to create a fraud proof credit card with the use of numbers only. The institution will enter the applicant's shipping address and telephone number into the Address Billing Computer Database (A.B.C.) database. The billing system bills, the actual numbers and letters of the applicant's shipping address. And it bills the actual numbers of the applicant's telephone number. The address and telephone number will detect fraud when used online, on the telephone, and in the mail. The merchant will match the phone number against a caller ID system, the merchant will employ a 1-800 number to prevent caller ID spoofing. The applicant will buy goods and pay for services using their address and telephone number. If the applicant lives in an apartment building the institution will turn the applicant's shipping numbers into two separate billing elements. After the address numbers are entered into the A.B.C. database. The institution will then enter the applicant's apartment letter, by translating the letter into a number; such as, if the applicant lives in Apartment E, the institution will translate the letter E, into the number 5, for the fifth letter of the alphabet.

The institution will also enter the date the account was established. The system will bill, and wire money with this date, 1982, when this date is used online, the merchant can see how long the consumer has done business with the institution. The institution will also enter the date the account will expire, the system will also bill and wire money with this date, 02/09. All of the billing numbers are manually entered into the A.B.C. database. A first computer database is used to manage the credit card numbers, this computer database system includes additional software processes. The applicant's name is then entered into the systems database. The computer will forward credit card data to, T.M.G. a Money Wiring, Address Billing, Online Fraud Detection System, is then issued. The institution will then put the numbers on the card using a Card Embosser. When the applicant receives the card, it can be activated by phone, just like today's credit cards.

### Operation

The manner of using this billing system is very simple and informative. If the address billing numbers are, 1234 10. After giving the systems numbers, and the merchant asks for a shipping address. The consumer replies, my shipping address is: 1234 10th Avenue. The merchant will then match and verify the address billing numbers by matching them to the consumer's shipping address to determine if they are a perfect match. If they were told for instance, the address is 1234 11th Avenue, they would know immediately that this transaction was fraudulent and will not bill the account.

If the consumer lives in a multi-unit apartment building it will work the same way. If the consumer's address is 1234 Oakdale Drive Apartment #16 the billing numbers will look like this, 1234 16. If the consumer lives in a building with letters only, let's say the letter E is on the door. The billing numbers would look like this, 1234 E. The merchant will translate the E into the number five 1234 5. for the fifth letter of the alphabet. If the consumer is purchasing a product with a mail order form, when the form is received by the merchant he or she will clearly see, and determine if it is fraudulent. The address and billing numbers will be exactly the same.

The billing system also employs the consumer's telephone number to wire the consumer money. This system will prevent fraud on all non-tangible purchases. Such as newspaper ads and internet services, and this number will be used to ship packages worldwide. The merchant will use a caller ID system to detect fraud, the merchant will employ a 1-800 number, or call the consumer back, to avoid caller ID spoofing. If the consumer is placing an order over the telephone, the merchant will ask the consumer for their telephone billing numbers. The merchant will then perform a one step process, and match each telephone billing number with the numbers on the caller ID. If one billing number is different from the numbers on the caller ID, the merchant will know it is fraud, and will not bill the account.

Banks will also have the option of using a valued customers date for billing numbers. The bank will wire money and bill the date the account was established. By doing so, the merchant can determine if the account is the result of identity theft. Such as, if the consumer is purchasing an item online, and the valued customers date is 1982, the merchant will not need to set a buying limit on this customer. This date will give the merchant the power to sell huge ticket items, safely. If the seller is running a fine art gallery that sells original oil paintings, this date will allow the seller to sell paintings that run in the multi-millions. The purchaser would use an internet debit card, for direct shipping only, 02/09 1982 2201 E 94606. The 02/09 is a money wiring expiration date, when the merchant sees this date the merchant will know the account will expire February 2009. The 1982 is the valued customers date; and, 2201 E 94606 are the cards direct shipping numbers. By combining the cardholders direct shipping numbers with the valued customer date, creates a powerful tool for the merchant. A card for shipping worldwide would look like this, 02/09 1982 58275 [3][7][3][9].

Even the issuing bank cannot commit fraud against it. The, 58275 are the last 5 digits of the consumer's telephone number, the 3 7 3 9. These numbers are used just like an ATM pin number, but they are not pin numbers, they are credit card numbers that are not printed on the card. The numbers are not printed on the card to prevent a family member from using the card. This system is for web sites that offer photo galleries, and other non-tangible services, and worldwide shipping. After the system is used by putting the complete card number on the web page, the web site will provide a 1-800 number for the consumer to prevent caller ID spoofing. The consumer will call the 800 number from the phone that is registered to the billing system. They will then be connected with an automated service with a caller ID system, once connected the transaction is complete. The merchant will employ a telephone with a printer, the phone will then print out the consumer's name and telephone billing numbers. The merchant will then complete the transaction with the information on the web site, using the printout of the consumer's telephone number as a billing authorization code. By matching the printout to the billing numbers on the web page.

The merchant now has the complete card number, and authorization to bill this account. And this same fraud proof system will be used to ship packages worldwide.

Banks can also issue world travel cards, which will look like this, 2201 10th 58275 [3][5][6][9]. This card is used when the consumer travels, places orders over the telephone, and mail orders. The 2201 10th, are the direct shipping numbers, this address will act as a locking system if the card numbers are stolen. The card will become a direct shipper only. The 58275 are the last 5 digits of the consumer's telephone number. This is for non-tangible services, and shipping packages worldwide. The last digits, 3 5 6 9 are not printed on the card. These numbers are used just like an ATM pin number, but they are not pin numbers, they are credit card numbers that are not printed on the card. The bank will leave these 4 numbers off the card, and not record the numbers on the magnetic strip on the back of the card. If the consumer is in a department store etc, buying goods, the last 4 digits are required at this time.

If this card was ever lost or stolen, it would be useless. This card does not operate on any special technology, you simply need to key in the last 4 digits of the card number in order to use the card in public. If the cardholder uses the card on a mail order form, or the telephone, the only numbers needed are, 2201 10th 58275.

### Objects and Advantages

Accordingly, several objects and advantages of the present invention are:

(a) An online billing system, that can be kept in plan view, without worry of it being stolen.
(b) An online billing system, that will allow merchants to safely ship thousands, or millions of dollars in merchandise with confidence.
(c) An online billing system, that merchants will not have any fraud charge backs with.
(d) An online billing system, that has numbers that cannot be stolen.
(e) An online billing system, that will make people feel good and safe, about shopping at home.
(f) An online billing system, that is 100% fraud proof.
(g) An online billing system, that protects the bank, the merchant, and the customer.
(h) An online billing system, that solves every credit card fraud problem in existence, without the use, or development of any major technology.

Further objects and advantages are to provide the merchant with valuable information. This Billing System can do this just by looking at its numbers. Such as, it verifies a person's mailing address, and it verifies a person's telephone number. The value customer date can protect a merchant against identity theft numbers.

1-9. (canceled)

10. I claim: An e-commerce money wiring payment code account billing expiration date, selective debit numbers are manually entered into the a b c database to create an account billing expiration date, the account expiration date numbers will inform when the account numbers will expire, if the billing numbers read 02/09, the money wiring date will expire February 2009,
a means for activating numeric data of said month and said year of an e-commerce money wiring payment code account billing expiration date.

11. I claim: An e-commerce money wiring payment code billing valued customer date identity theft evaluator, selective numbers are manually entered into the a b c database to create a 4 digit money wiring account establishment date, to inform the year and length of time the account was established, the billing numbers date is then employed online as an identity theft evaluator,
a means for activating numeric data for an e-commerce money wiring payment code billing valued customer date identity theft evaluator,
whereby an e-commerce money wiring valued customer date which will increase the volume of sales and inform the merchant of possible identity theft billing numbers.

12. I claim: An e-commerce money wiring address billing direct shipping payment code, with translating shipping letters, for e-commerce payment processing, shipping addresses and translating shipping letters are manually entered into the a b c database for wiring money providing fraud detecting debit transactions, money wiring address billing letters will translate into numbers, the letter e will translate into the number 5 for the fifth letter of the alphabet, the address billing shipping numbers will be matched to each number of a shipping address for verification of ownership of the systems numbers and fraud detection,
a means for activating said address billing numbers and said address billing letters for an active address billing money wiring payment code fraud detection system, whereby a 100 percent fraud proof payment processing address billing direct shipper online fraud detection system.

13. I claim: An e-commerce money wiring telephone number payment code, for non-tangible services, and shipping packages worldwide, providing caller id data for account ownership verification and payment processing, telephone numbers are manually entered into the a b c database for wiring money providing fraud detecting debit transactions online, transactions can only be authorized from the telephone that is registered to said money wiring telephone number payment code, transactions will be processed and completed by matching providing said caller id system data to said money wiring telephone number payment code, for verification of ownership of the systems numbers and fraud detection,
a means for activating said money wiring telephone number payment code for providing said caller Id system verification,
whereby a 100 percent fraud proof payment processing fraud preventing telephone number worldwide shipper online fraud detection system.
